(19) United States
(12) Patent Application Publication
(10) Pub. No.: US 2011/0253773 A1
(43) Pub. Date: Oct. 20, 2011

(54) INSULATED PIZZA BOX AND METHOD OF MANUFACTURE

(76) Inventor: James R. LOZIER, Hamilton Square, NJ (US)

(21) Appl. No.: 12/763,828

(22) Filed: Apr. 20, 2010

(51) Int. Cl. B65D 5/56; B31B 1/16; B31B 7/00

(52) U.S. Cl. 229/103.11; 493/95; 493/56; 493/903

(57) ABSTRACT

The present invention relates to an insulated pizza box and method for manufacture in which the pizza box includes a layer of an insulation material applied to all inner surfaces of the box. The insulated pizza box can be formed by adhering a layer of an insulation material to the material forming the pizza box. In one embodiment, the layer of the insulation material is applied to a sheet of a corrugated material. The layer of insulation material can be a layer of aluminum foil or a foil like material. The sheet can be die cut into container blanks and scored at appropriate points so that the blank can be folded into the pizza box.

### BACKGROUND OF THE INVENTION

1. Field of the Invention

The present invention relates to an insulated pizza box and a method of manufacture in order to create a thermally insulated box for limiting conduction and retaining heat released from the pizza.

2. Description of Related Art

Conventional pizza boxes are known. U.S. Pat. No. 4,265,393 describes a box of cardboard, paperboard, fiberboard or the like assembled from a single, die cut blank comprising a bottom wall, side walls, front and back walls, and a swingable top closure. The side walls are provided with inturned flanges underlying a flange extending rearwardly from the front wall which latter contains outwardly projecting stops. The top wall carries locking tabs for restrictive abutting relationship with the proximate stop and which tabs embody tongues lockingly engageable in openings in the side wall; providing abutments for limiting lateral shifting of the top wall when the box is closed.

U.S. Pat. No. 4,237,171 describes an insulated and moisture absorbent food container. The container is formed of an inner layer of absorbent paperboard adhered to an outer layer of resinous foam insulating material. The inner paperboard layer has an absorbent porous surface and has sufficient thickness and rigidity to lend body to the container. The outer foam layer is sufficiently thick to insulate and prevent moisture leakage.

U.S. Pat. No. 4,717,069 relates to a carton for hot foods in which the bottom wall of the carton comprises a plurality of layers which enclose therebetween a plurality of void spaces that serve to limit conduction of heat from hot food positioned on the upper surface of the bottom wall to a cold surface on which the bottom surface of the bottom wall rests. The void spaces may take the form of a plurality of generally conical dimples depressed into the lower layer of the bottom wall or may take the form of elongated V-shaped grooves or furrows depressed into the lower layer of the bottom wall. The above-described patents for insulating boxes change the structure of a conventional food carton and do not provide complete insulation of all inner surfaces of the box.

It is desirable to provide a method for forming an improved pizza box from a conventional pizza box by insulation of inner surfaces of the box.

### SUMMARY OF THE INVENTION

The present invention relates to an insulated pizza box and method for manufacture in which the pizza box includes a layer of an insulation material applied to all inner surfaces of the box. The insulated pizza box retains heat released from the pizza within the insulated pizza box and limits conduction of heat from the pizza outside of the box.

The insulated pizza box can be formed by adhering a layer of an insulation material to the material forming the pizza box. In one embodiment, the layer of the insulation material is applied to a sheet of a corrugated material. The layer of insulation material can be a layer of aluminum foil or a foil like material. The sheet can be die cut into container blanks and scored at appropriate points so that the blank can be folded into the pizza box.

The insulated pizza box can be manufactured with low manufacturing costs. After use of the box, the insulation material and the pizza box can be separated to allow recycling of the box and/or the insulation material. Accordingly, the pizza box is environmentally friendly.

The invention will be more fully described by reference to the following drawings.

### BRIEF DESCRIPTION OF THE DRAWINGS

FIG. 1 is a perspective view of an insulated pizza box with the lid open in accordance with the teachings of the present invention.

FIG. 2 is a top plan view of a sheet of material having an insulation material adhered thereto.

FIG. 3 is a top plan view of the blank of the sheet of material having adhered thereto the insulation material when the pizza box is laid flat prior to being folded into a pizza box configuration.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

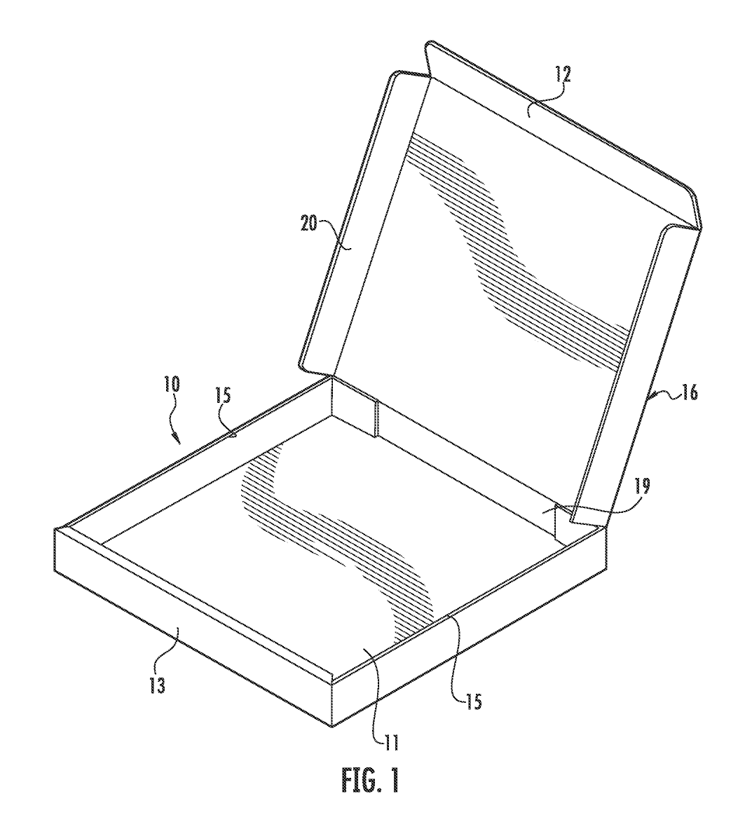

FIG. 1 is a perspective view of insulated box 10 in accordance with the teachings of the present invention. In a preferred embodiment, insulated box 10 is used for holding a hot pizza. Alternatively, insulated box 10 can have an appropriate shape and be used for holding other types of hot food items. Insulated box 10 includes main body 11 for holding the hot food item and lid 12 for covering the hot food item. Main body 11 includes front 13, rear 14 and side walls 15. Main body 11 and lid 12 can be formed of a single blank of material 16 which is are folded into insulated box 10. Material 16 can be formed of a corrugated board or paper board. Corrugated board can include two outer sheets of paper adhered to an inner corrugated sheet.

Insulation layer 20 is adhered to all inner surfaces of main body 11 and lid 12 of insulated box 10. Insulation layer 20 can be formed of a thermal insulation material for reducing heat transfer from a hot food item placed within insulated box 10. Suitable materials for insulation layer 20 include aluminum foil, metalized films, foils formed of metal alloys and foil like materials. Insulation layer 20 can have a thickness in the range of about 0.001 to about 0.008 inches.

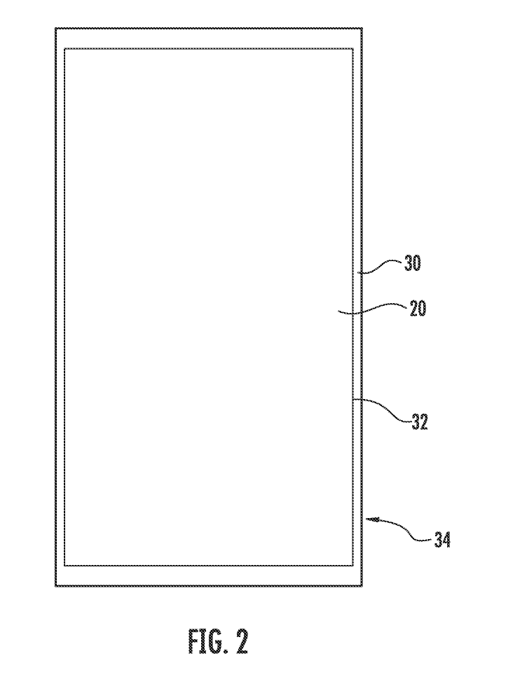

FIG. 2 is a top plan view of insulation layer 20 adhered to sheet of material 30 during the method for forming insulated box 10. Insulation layer 20 and sheet of material 30 can be bonded together with pressure sensitive adhesive 32 to form laminated sheet 34. Pressure sensitive adhesive 32 can be applied to sheet of material 30 and insulation layer 20 can be adhered thereto. Pressure sensitive adhesive 32 can be applied by brush, roller or spray gun. Pressure sensitive adhesive 32 can be resistant to heat and moisture to prevent delamination once a hot pizza is placed into the container. In one embodiment, pressure sensitive adhesive 32 allows insulation layer 20 to be removed from sheet of material 30 after use for recycling of insulation layer 20 and/or sheet of material 30. Alternatively, a rubber base adhesive can be used.

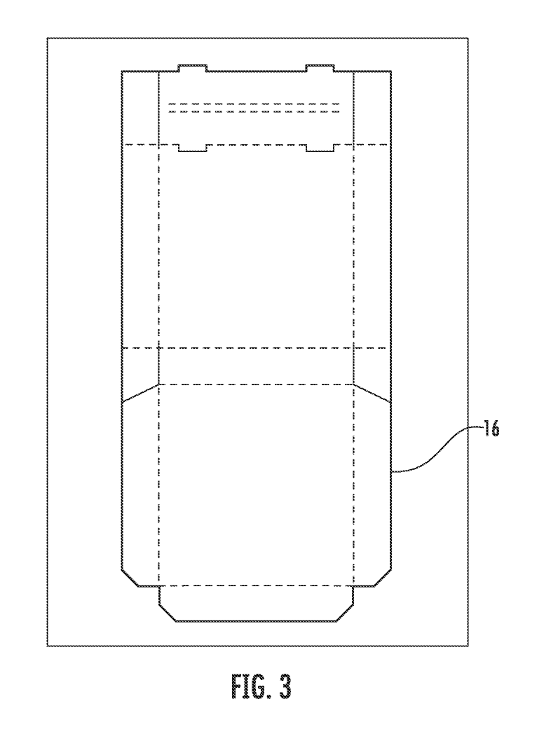

FIG. 3 is a top plan view of blank 16 which can cut from sheet of material 30. Blank 16 can be cut and scored at appropriate points to allow blank 16 to be folded into insulated box 10. Blank 16 can be formed of various shapes corresponding to a shape of a conventional pizza box.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method of making an insulated box comprising:
providing a sheet of material;
adhering a thermal insulation layer to the sheet of material to form a laminated sheet; and
cutting the laminated sheet into a blank,
wherein the blank is adapted for being folded for forming the insulated box from the blank in which inner surfaces of the insulated box are formed of said thermal insulation layer.

2. The method of claim 1 wherein the sheet of material is corrugated board.

3. The method of claim 1 wherein the thermal insulation layer is a foil.

4. The method of claim 1 wherein the thermal insulation layer is aluminum foil.

5. The method of claim 1 wherein the thermal insulation layer is metalized.

6. The method of claim 1 wherein the thermal insulation layer is adhered to said sheet of material with a pressure sensitive adhesive.

7. A pizza box formed from the blank according to the method of claim 1.

8. In a box for a hot food product for keeping the hot food product warm, the box including a main body having front, rear and sidewalls and having a lid, the improvement wherein the inner surfaces of the front, rear and side walls and said lid are formed of a thermal insulation material.

9. The box according to claim 8 wherein said box is a pizza box.

10. The box of claim 8 wherein the thermal insulation layer is a foil.

11. The box of claim 8 wherein the thermal insulation layer is aluminum foil.

12. The box of claim 8 wherein the thermal insulation layer is metalized.

13. The box of claim 8 wherein the thermal insulation layer is adhered to said sheet of material with a pressure sensitive adhesive.

14. A method for making a blank for forming a box comprising the steps of:
providing a sheet of material;
adhering a thermal insulation layer to the sheet of material to form a laminated sheet; and
cutting the laminated sheet into a blank, wherein the blank is adapted for being folded for forming the insulated box from the blank in which inner surfaces of the insulated box are formed of said thermal insulation layer.

15. The method of claim 10 wherein the sheet of material is corrugated board.

16. The method of claim 10 wherein the thermal insulation layer is a foil.

17. The method of claim 10 wherein the thermal insulation layer is aluminum foil.

18. The method of claim 10 wherein the thermal insulation layer is metalized.

19. The method of claim 10 wherein the thermal insulation layer is adhered to said sheet of material with a pressure sensitive adhesive.

20. A pizza box formed from the blank according to the method of claim 10.
